(19) United States
(12) Patent Application Publication
(10) Pub. No.: US 2025/0051975 A1
(43) Pub. Date: Feb. 13, 2025

(54) SYSTEMS AND METHODS FOR PRODUCING A BUNDLE OF FILAMENTS AND/OR A YARN

(71) Applicant: ALADDIN MANUFACTURING CORPORATION, Calhoun, GA (US)

(72) Inventors: Anthony CASCIO, Calhoun, GA (US); James MASON, Calhoun, GA (US); Daniel AMOS, Calhoun, GA (US); Lucinda JONES, Calhoun, GA (US); Margaret Archelle BAILEY, Calhoun, GA (US); Michael Christopher GALLMAN, Calhoun, GA (US); Jeffrey Frank MERRICK, Calhoun, GA (US); Garnett Anson WATKINS, JR., Calhoun, GA (US)

(21) Appl. No.: 18/719,783

(22) PCT Filed: Dec. 2, 2022
(86) PCT No.: PCT/IB2022/061696

§ 371 Date: Jun. 13, 2024

Related U.S. Application Data
(60) Provisional application No. 63/361,397, filed on Dec. 15, 2021.

(51) Int. Cl. D02G 3/04; D01D 5/08; D01D 11/00; D01D 13/00; D02G 3/24; D02G 3/34

(52) U.S. Cl. CPC D02G 3/045; D01D 5/08; D01D 11/00; D01D 13/00; D02G 3/24; D02G 3/346; D10B 2401/14

(57) ABSTRACT

Systems for producing M bundles of filaments, wherein M>1, include N extruders. M spin stations, and a processor, wherein N>1. Each extruder includes a polymer having a color, hue, luster, and/or dyability characteristic, which are different from each other. Each spin station produces N bundles of filaments that form a yarn. Each spin station comprises N spinnerets through which filaments are spun from molten polymers streams received by the respective spin station and N′ spin pumps upstream of the N spinnerets for the respective spin station. Each spin pump is paired with one of the Nextruders. The processor is in electrical communication with the N*M spin pumps and is configured to adjust the volumetric flow rate of the polymers pumped from each spin pump to achieve a ratio of the polymers to be included in the yarn from each spin station.

### BACKGROUND

Melt spun filaments, such as melt spun filaments of PET are known in the art. Some types of polymers, hence filaments, strands or bundles, are difficult to dye, or to provide with a color varying along the length of the filament, bundle or strand.

It is known to change the color of filaments in a bundle by changing the dye sourcing. However, this process is time consuming and can be wasteful. In addition, it is also known in US Published Patent Application No. 2010/0297442 to vary the output of spin pumps when spinning a plurality of filament bundles that each have a different color to provide a color variation along the length of a composite thread made with the plurality of filament bundles.

However, a need in the art exists for systems and methods for improving the color variation of a bundle of filaments and/or a yarn.

### BRIEF SUMMARY

Various implementations include systems and methods of providing multifilament bundles of melt spun polymer filaments that provide a color variation along the length of the filament, bundle, or strand.

According to a first aspect, a system for producing a bundle of filaments comprises N extruders, wherein N is an integer greater than 1, M spin stations, wherein M is an integer of 1 or more, and a processor. Each extruder comprises a polymer having a color, hue, luster, and/or dyability characteristic. The colors, hues, lusters and/or dyability characteristics of the polymers in the N extruders are different from each other. M spin stations are for receiving molten polymer streams from the N extruders. Each spin station spins N bundles of filaments that are combined into a yarn. Each spin station comprises N spinnerets through which a plurality of melt-spun filaments are spun from each of the N molten polymer streams received by the spin station and N spin pumps upstream of the N spinnerets. Each spin pump is in fluid communication and is paired with one of the N extruders. The processor is in electrical communication with the N*M spin pumps. The processor is configured to execute computer readable instructions that cause the processor to adjust a volumetric flow rate of the polymers pumped by each spin pump in each spin station to achieve a ratio of the polymers to be included in the yarn that comprises the N bundles of filaments spun from the respective spin station. The volumetric flow rates extruded by each of the spin pumps in a respective one of the M spin stations is greater than zero and is variable such that flow of the polymer streams through the spinnerets of the respective spin station is continuous and supports continuous filament formation and wherein the volumetric flow rate of at least one pump in each spin station is variable by more than +40% of a baseline volumetric flow rate, wherein the baseline volumetric flow rate is equal to a total volumetric flow rate through the spin station divided by N.

In some implementations, the instructions further cause the processor to determine the volumetric flow rate of each polymer to be pumped by each spin pump and generate the instructions to the spin pumps based on the volumetric flow rate determinations.

In some implementations, the instructions also cause the processor to adjust the timing of the volumetric flow rate changes and hence adjust the corresponding denier and/or color changes in the yarn. The instructions cause the processor to adjust the speeds and volumetric flow rates of some or all of the spin pumps for an amount of time based on a desired color variation in the yarn.

In some implementations, the instructions cause the processor 110 to randomize the amount of time that the speeds and volumetric flow rates through some or all of the spin pumps are varied.

In some implementations, M is greater than 1 and the system comprises at least a first spin station and a second spin station, wherein the ratio is a first ratio for the first spin station and a second ratio for the second spin station, and wherein a sum of the volumetric flow rates extruded from each extruder by the spin pumps paired with the respective extruder varies 0 to ±5%. In some implementations, the first ratio and the second ratio are different.

In some implementations, an average denier of each yarn varies by ±5% or less along a length of each yarn.

In some implementations, the yarn from each M spin station has a color, hue, luster, and/or dyability characteristic that is a mixture of the color, hue, luster, and/or dyability characteristic of the polymers being extruded from the N extruders.

In some implementations, M is two or more, and the ratios to be included in each of the M yarns are different.

In some implementations, the system further comprises at least one drawing device to elongate said N bundles of spun filaments; an initial tacking device upstream to or integrated within the at least one drawing device to tack at least one of said N bundles of spun filaments prior to or during the elongation of the N bundles of spun filaments; at least one texturizer to texturize said N bundles of elongated spun filaments; and a final tacking device to tack said N bundles of texturized spun filaments to provide a BCF yarn.

In some implementations, the at least one texturizer comprises at least a first texturizer and a second texturizer, and at least one of said N bundles of spun filaments is texturized individually from the other N bundles of spun filaments through the first texturizer.

In some implementations, the at least one texturizer comprises N texturizers, and each of said N bundles of spun filaments are texturized individually from each other through respective N texturizers.

In some implementations, the system further comprises an intermediate tacking device and a mixing cam disposed between the at least one texturizer and the final tacking device, the intermediate tacking device for tacking at least one of said N bundles of texturized spun filaments and the mixing cam for positioning tacked and texturized bundles relative one to the other before reaching the final tacking device.

In some implementations, the system further comprises at least one drawing device to elongate said N bundles of spun filaments; at least a first texturizer and a second texturizer, wherein at least one of said N bundles of elongated spun filaments is texturized individually through the first texturizer separately from the other said N bundles of elongated spun filaments; and a final tacking device to tack said N bundles of texturized spun filaments to provide a BCF yarn.

In some implementations, the system further comprises an intermediate tacking device disposed between the at least one texturizer and the final tacking device, the intermediate tacking device for tacking at least one of said N bundles of texturized spun filaments.

In some implementations, the system further comprises a mixing cam disposed between the at least one texturizer and the final tacking device, the mixing cam for positioning tacked and texturized bundles relative to one to the other before reaching the final tacking device.

In some implementations, the system further comprises at least one drawing device to elongate said N bundles of spun filaments; at least one texturizer to texturize said N bundles of elongated spun filaments; a second tacking device disposed between the texturizers and the final tacking device, the second tacking device for tacking at least one of said N bundles of texturized spun filaments; and a final tacking device to tack said N bundles of texturized spun filaments to provide a BCF yarn.

In some implementations, the system further comprises a mixing cam disposed between the texturizers and the final tacking device, the mixing cam for positioning tacked and texturized bundles relative to one to the other before reaching the final tacking device.

In some implementations, a plurality of bundles of filaments are produced using the system according to the first aspect.

In some implementations, a yarn includes the bundles of filaments produced using the system of the first aspect.

And, in some implementations, the yarn is a bulked continuous filament (BCF) yarn.

According to a second aspect, a method to produce at least one bundle of filaments comprises (1) providing N streams of molten polymer, wherein N is an integer greater than 1, and each stream has a different color, hue, luster, and/or dyability characteristic; (2) providing M spin stations, wherein M is an integer of 1 or more, each spin station having N plates for receiving the N streams of polymer, N spinnerets, and N spin pumps, each spin pump pumping one of the N streams of polymer to one of the N plates, and each of the N plates being in fluid communication with one of the N spinnerets, the N spin pumps being disposed upstream of N plates and N spinnerets; and (3) adjusting a volumetric flow rate of each polymer stream pumped to the respective spinneret of the spin station to achieve a ratio of the polymer streams to be included in a yarn, the yarn comprising bundles of filaments spun from the spinnerets of each spin station, wherein the volumetric flow rate extruded by each spin pump in a respective one of the M spin stations is greater than zero and is variable such that the flow of the polymer streams through the spinnerets of the respective spin station is continuous and supports continuous filament formation and wherein the volumetric flow rate of at least one pump in each spin station is variable by more than ±40% of a baseline volumetric flow rate, wherein the baseline volumetric flow rate is equal to a total volumetric flow rate through the spin station divided by N.

In some implementations, M is greater than one, and the M spin stations comprise a first spin station and a second spin station, and the ratio is a first ratio for the first spin station and a second ratio for the second spin station, and a sum of the volumetric flow rates extruded from each extruder by the spin pumps paired with the respective extruder varies 0 to ±5%.

In some implementations, the first ratio and the second ratio are different.

In some implementations, a plurality of bundles of filaments are produced according to the method of the second aspect. In some implementation, a yarn comprises the bundles of filaments produced using the method according to the second aspect. In some implementations, the yarn is a bulked continuous filament (BCF) yarn.

According to a third aspect, a yarn comprises a plurality of bundles of filaments, wherein at least two of the bundles of filaments have different colors, hues, lusters, and/or dyability characteristics, and a sum of areas of radial cross-sections of filaments in each respective bundle of filaments varies along a length of the respective bundle of filaments. In other words the denier per filament of filaments in one or more bundles of filaments is varied along their length. An increase of the denier per filament in a certain bundle leads to the properties, such as color, hue, luster, and/or dyability, of these filaments to become more prevalent within the yarn. By varying the denier in two or more bundles of differently colored filaments, an effect may be obtained which is interpreted by the human eye as a mixed color. For example, when a bundle of yellow filaments and a bundle of cyan filaments are present in the yarn, green may be obtained when both bundles have filaments of about equal size. And, as the filament size of the cyan filaments are decreased and the filament size of the yellow filaments are increased, the yarn may turn more and more yellow to the human eye, or more and more cyan when the variation in size is opposite.

In some implementations, a sum of the areas of the radial cross-sections of all filaments in a radial cross-section of the yarn varies by 5% or less along a length of the yarn.

In some implementations, for filaments in the same bundle of filaments, the variation in the area of the radial cross-section along the length of each filament occurs at a common radial cross-section of the respective bundle of filaments, the common radial cross-section of the respective bundle of filaments lying within a plane that perpendicularly intersects a central axis of the respective bundle of filaments. Put differently, the variation of the denier per filament is preferably substantially synchronized in a bundle.

In some implementations, within a plane that perpendicularly intersects a central axis of the yarn, the sum of the areas of radial cross-sections of the filaments in one respective bundle of filaments is different than the sum of areas of radial cross-sections of the filaments in at least one other bundle of filaments. The yarn of the third aspect may be obtained in various manners, including using a system of the first aspect and/or using the method of the second aspect, and/or their respective preferred implementations. Preferably a bundle of filaments in the yarn of the third aspect is obtained from the respective spinnerets mentioned in the first and/or second aspect. The yarn of the third aspect may further show preferred characteristics equal or similar to yarns obtained with the first and/or second aspect, without necessarily having been obtained in that manner.

In some implementations, the filaments have a multi-lobal cross section. For example, some implementations have a three-lobal (or tri-lobal) cross-section. The multi-lobal cross-section is advantageous, since the filaments with larger cross-section tend to hide the filaments with smaller cross-section more effectively, such that a broader range of variation in properties, such as color, hue, luster, and dyability, can be obtained when varying the size of the filaments in the respective bundles.

In some implementations, the filaments of one or more bundles comprised in the yarn are colored, preferably with a dye extending through the full mass of the filament.

In a fourth aspect, a carpet, rug, or carpet tile (collectively referred to herein as “carpet”) is provided comprising pile made with the yarn of the third aspect and/or obtained using the methods and/or systems of any of the first or second aspects.

### BRIEF DESCRIPTION OF THE DRAWINGS

Example features and implementations are disclosed in the accompanying drawings. However, the present disclosure is not limited to the precise arrangements shown, and the drawings are not necessarily drawn to scale.

FIG. 1 illustrates a schematic diagram of a system according to one implementation.

FIG. 2 illustrates a roll of yarn made using the system of FIG. 1 and a radial cross-section of the yarn, according to one embodiment.

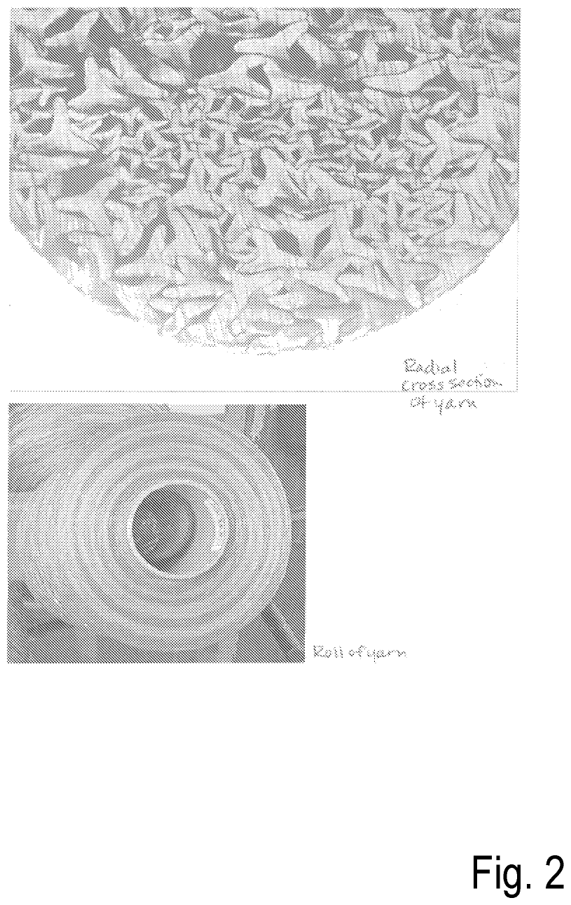

FIG. 3 illustrates an example computing device that can be used according to embodiments described herein.

FIG. 4 illustrates a schematic diagram of optional post-spinning processes for the system shown in FIG. 1.

### DETAILED DESCRIPTION

Various implementations include systems and methods for producing bundles of filaments, yarn(s) made therefrom, and carpet(s) made from the yarn. The system allows for the color effect of or mix of colors within a yarn to be changed by altering the volumetric flow rate of spin pumps that are in fluid communication and paired with a plurality of extruders that each include a polymer having a different color, hue, luster, and/or dyability characteristic than the other extruders.

According to a first aspect, a system for producing a bundle of filaments, the system comprises N extruders, wherein N is an integer greater than 1, M spin stations, wherein M is an integer of 1 or more, and a processor. Each extruder comprises a polymer having a color, luster, hue, and/or dyability characteristic. The colors, hues, lusters, and/or dyability characteristics of the polymers in the N extruders are different from each other. M spin stations are for receiving molten polymer streams from the N extruders. Each spin station spins N bundles of filaments that are combined into a yarn. Each spin station comprises N spinnerets through which a plurality of melt-spun filaments are spun from each of the N molten polymer streams received by the spin station and N spin pumps upstream of the N spinnerets. Each spin pump is in fluid communication and is paired with one of the N extruders. The processor is in electrical communication with the N*M spin pumps. The processor is configured to execute computer readable instructions that cause the processor to adjust a volumetric flow rate of the polymers pumped by each spin pump in each spin station to achieve a ratio of the polymers to be included in the yarn that comprises the N bundles of filaments spun from the respective spin station. The volumetric flow rates extruded by each of the spin pumps in a respective one of the M spin stations is greater than zero and is variable such that flow of the polymer streams through the spinnerets of the respective spin station is continuous and supports continuous filament formation and is variable by more than +40% of a baseline volumetric flow rate, wherein the baseline volumetric flow rate is equal to a total volumetric flow rate through the spin station divided by N.

According to a second aspect, a method to produce at least one bundle of filaments comprises (1) providing N streams of molten polymer, wherein N is an integer greater than 1, and each stream has a different color, hue, luster, and/or dyability characteristic; (2) providing M spin stations, wherein M is an integer of 1 or more, each spin station having N plates for receiving the N streams of polymer, N spinnerets, and N spin pumps, each spin pump pumping one of the N streams of polymer to one of the N plates, and each of the N plates being in fluid communication with one of the N spinnerets, the N spin pumps being disposed upstream of N plates and N spinnerets; and (3) adjusting a volumetric flow rate of each polymer stream pumped to the respective spinneret of the spin station to achieve a ratio of the polymer streams to be included in a yarn, the yarn comprising bundles of filaments spun from the spinnerets of each spin station, wherein the volumetric flow rate extruded by each spin pump in a respective one of the M spin stations is greater than zero and is variable such that the flow of the polymer streams through the spinnerets of the respective spin station is continuous and supports continuous filament formation and wherein the volumetric flow rate of at least one pump in each spin station is variable by more than ±40% of a baseline volumetric flow rate, wherein the baseline volumetric flow rate is equal to a total volumetric flow rate through the spin station divided by N.

According to a third aspect, a yarn comprises a plurality of bundles of filaments, wherein at least two of the bundles of filaments have different colors, hues, lusters, and/or dyability characteristics, and a sum of areas of radial cross-sections of filaments in each respective bundle of filaments varies along a length of the respective bundle of filaments.

In a fourth aspect, a carpet, rug, or carpet tile (collectively referred to herein as “carpet”) is provided comprising pile made with the yarn of the third aspect and/or obtained using the methods and/or systems of any of the first or second aspects.

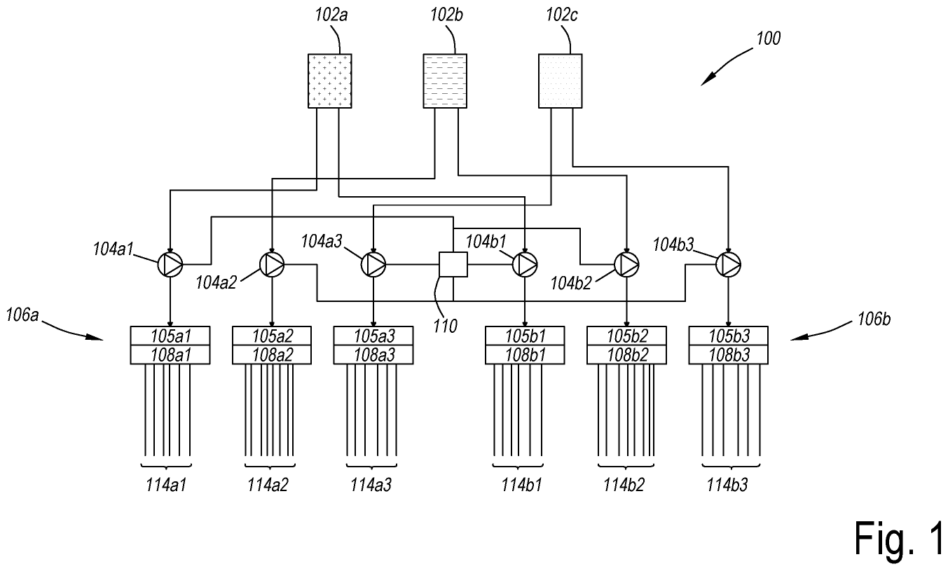

For example, FIG. 1 illustrates a schematic diagram of a system according to one implementation. The system 100 includes a first extruder 102a, a second extruder 102b, a third extruder 102c, a first spin station 106a, and a second spin station 106b. Each spin station 106a, 106b includes three spinneret 108a1, 108a2, 108a3, 108b1, 108b2, 108b3, a first spin pump 104a1, 104b1, a second spin pump 104a2, 104b2, a third spin pump 104a3, 104b3, and manifold plates 105a1, 105a2, 105a3, 105b1, 105b2, 105b3 through which molten polymer streams flow from the pumps 104a1, 104a2, 104a3, 104b1, 104b2, 104b3 to the spinnerets 108a1, 108a2, 108a3, 108b1, 108b2, 108b3. The system 100 also includes a processor 110 in electrical communication with the spin pumps 104a1, 104a2, 104a3, 104b1, 104b2, and 104b3. The first spin pumps 104a1, 104b1 are in fluid communication and are paired with the first extruder 102a, the second spin pumps 104a2, 104b2 are in fluid communication and are paired with the second extruder 102b, and the third spin pumps 104a3, 104b3 are in fluid communication and are paired with the third extruder 102c.

Each extruder 102a, 102b, 102c includes a polymer having a color, hue, luster, and/or dyability characteristic. The colors, hues, lusters, and/or dyability characteristics in each extruder 102a, 102b, 102c are different from each other. Spin pumps 104a1, 104a2, 104a3, 104b1, 104b2, 104b3 pump the molten polymer through the plates 105a1, 105a2, 105a3, 105b1, 105b2, 105b3, which feeds the molten polymer through the spinnerets 108a1, 108a2, 108a3, 108b1, 108b2, 108b3.

Bundles of filaments 114a1, 114a2, 114a3 are spun through spinnerets 108a1, 108a2, 108a3 spin, respectively, of the first spin station 106a, and these bundles 114a1, 114a2, 114a3 are eventually processed into a first yarn. And, bundles of filaments 114b1, 114b2, 114b3 are spun through spinnerets 108b1, 108b2, 108b3, respectively, of the second spin station 106b, and these bundles 114b1, 114b2, 114b3 are eventually processed into a second yarn.

In some implementations, the polymer of one or more of the N extruders may comprise a thermoplastic polymer. Examples of thermoplastic polymers that may be used for the filaments named in any of the first through fourth aspects include polyamides, polyesters, and/or polyolefins.

A polyamide is defined as a synthetic linear polymer whose repeating unit contains amide functional groups, wherein these amide functional groups are integral members of the linear polymer chain.

In some embodiments of any of the aspects described herein, the polyamide may have been formed by condensation polymerization of a dicarboxylic acid and a diamine. Representative examples of such dicarboxylic acids include terephthalic acid, isophthalic acid, 2,6-napthalene dicarboxylic acid, 3,4′-diphenylether dicarboxylic acid, hexahydrophthalic acid, 2,7-naphthalenedicarboxylic acid, phthalic acid, 4,4′-methylenebis (benzoic acid), oxalic acid, malonic acid, succinic acid, methyl succinic acid, glutaric acid, adipic acid, 3-methyladipic acid, pimelic acid, suberic acid, azelaic acid, sebacic acid, 1,11-undecanedicarboxylic acid, 1,10-dodecanedicarboxylic acid, 1,12-dodecanedicarboxylic acid, hexadecanedioic acid, docosanedioic acid, tetracosanedioic acid, 1,4-cyclohexanedicarboxylic acid, 1,3-cyclohexanedicarboxylic acid, 1,2-cyclohexanediactic acid, fumaric acid, and maleic acid. Representative examples of such diamines include ethylene diamine, tetramethylene diamine, hexamethylene diamine, 1,9-nonanediamine, 2-methyl pentamethylene diamine, trimethyl hexamethylene diamine (TMD), m-xylylene diamine (MXD), and 1,5-pentanediamine.

In some embodiments of any of the aspects described herein, the polyamide may have been formed by condensation polymerization of an amino acid (such as 11-aminoundecanoic acid) or ring-opening polymerization of a lactam (such as caprolactam or @-aminolauric acid).

Representative examples of polyamides as may be used in the present disclosure include: aliphatic polyamides such as polyamide 6, polyamide 11, polyamide 12, polyamide 46, polyamide 410, polyamide 4T, polyamide 510, polyamide D6, polyamide DT, polyamide DI, polyamide 66, polyamide 610, polyamide 612, polyamide 6T, polyamide 6I, polyamide MXD6, polyamide 9T, polyamide 1010, polyamide 10T, polyamide 1212, polyamide 12T, polyamide PACM12, polyamide TMDT, polyamide 611, and polyamide 1012; polyphthalimides such as polyamide 6T/66, polyamide LT/DT, and polyamide L6T/6I; and aramid polymers.

In some particular embodiments, the first polymer comprises polyamide 6,6. In other particular embodiments, the first polymer comprises polyamide 6.

In some examples, the polymer may be aromatic or aliphatic polyamide, such as PA6, PA66, PA6T, PA10, PA12, PA56, PA610, PA612, PA510, or any combination thereof. The polyamide can be a homopolymer or a copolymer of amide monomers and/or can be partially recycled or fully based upon recycled polyamide.

A polyester is defined as a synthetic linear polymer whose repeating units contain ester functional groups, wherein these ester functional groups are integral members of the linear polymer chain.

Typical polyesters as used in the present disclosure may be formed by condensation of a dicarboxylic acid and a diol. Representative examples of such dicarboxylic acids include terephthalic acid, isophthalic acid, 2,6-naphthalene dicarboxylic acid, 3,4′-diphenylether dicarboxylic acid, hexahydrophthalic acid, 2,7-napthalene dicarboxylic acid, phthalic acid, 4,4′-methylenebis (benzoic acid), oxalic acid, malonic acid, succinic acid, methyl succinic acid, glutaric acid, adipic acid, 3-methyladipic acid, pimelic acid, suberic acid, azelaic acid, sebacic acid, 1,11-undecanedicarboxylic acid, 1,10-dodecanedicarboxylic acid, 1,12-dodecanedicarboxylic acid, hexadecanedioic acid, docosanedioic acid, tetracosanedioic acid, 1,4-cyclohexanedicarboxylic acid, 1,3-cyclohexanedicarboxylic acid, 1,2-cyclohexanediacetic acid, fumaric acid, and maleic acid. Representative examples of such diols include monoethylene glycol, diethylene glycol, triethylene glycol, poly (ethylene ether) glycols, 1,3-propanediol, 1,4-butanediol, poly (butylene ether) glycols, pentamethylene glycol, 1,6-hexanediol, 1,8-octanediol, 1,10-decanediol, 1,12-dodecanediol, 1,14-tetradecanediol, 1,16-hexadecanediol, cis-1,4-cyclohexanedimethanol, and trans-1,4-cyclohexanedimethanol.

Representative examples of polyesters include poly (ethylene terephthalate) (PET), poly (trimethylene terephthalate) (PTT), poly (butylene terephthalate) (PBT), poly (ethylene isophthalate), poly (octamethylene terephthalate), poly (decamethylene terephthalate), poly (pentamethylene isophthalate), poly(butylene isophthalate), poly (hexamethylene isophthalate), poly (hexamethylene adipate), poly (pentamethylene adipate), poly (pentamethylene sebacate), poly (hexamethylene sebacate), poly (1,4-cyclohexylene terephthalate), poly (1,4-cyclohexylene sebacate), poly (ethylene terephthalate-co-sebacate), and poly (ethylene-co-tetramethylene terephthalate).

In some examples, the polyester can be polyethylene terephthalate (PET), polybutylene terephthalate (PBT), or polytrimethylene terephthalate (PTT). The PET can be virgin PET or partially or fully based upon recycled PET, such as the PET described in U.S. Pat. No. 8,597,553.

In some examples, the polyolefin can be polyethylene (PE), polypropylene (PP), or an ethylene-propylene copolymer.

In certain implementations, the polymer is PET, PTT, PP, PA6, PA66 or PES.

In some implementations, the N extruders can comprise different thermoplastic polymers, for example, one or more of the N extruders can comprise polyamides, one or more of the N extruders can comprise polyesters, and/or one or more of the N extruders can comprise polyolefins. In other implementations, two or more N extruders can comprise different polyamides, two or more N extruders can comprise different polyesters, and/or two or more N extruders can comprise different polyolefins.

In other implementations according to any of the aspects described herein, the polymer may be a thermoset polymer. For example, a thermoset polymer may include polyurethane, polysiloxane, polyurea, melamine formaldehyde, polyepoxide, polyimide, polyoxybenzylmethylenglycolanhydride, polycyanurate, urea-formaldehyde, or any combination thereof.

In some implementations of any of the first through fourth aspects, the bundles are made from the same polymer. However, in other implementations, bundles may be made from different polymers. For example, in certain implementations in which the bundles are made from different polymers, the bundles include filaments comprising a polyamide and filaments comprising a polyester. In further or additional implementations, the bundles include filaments comprising a polyolefin. The resulting bundle exhibits improved flammability performance from the filaments comprising polyester and increased staining performance from the filaments comprising polyamide, according to some implementations.

In some implementations of the systems and method described herein, the system includes a first extruder and a second extruder, wherein the first extruder comprises a first polymer and the second extruder comprises a second polymer that is different from the first polymer. For example, the first polymer includes a polyamide and the second polymer includes a polyester. In further implementations, the system includes a third extruder comprising a third polymer. The third polymer may, for example, comprise a polymer that is the same as or different from one or both of the polymers in the first and second extruders. For example, the second polymer may be deep-dye PET and the third polymer may be regular-dye PET.

In some implementations of the systems and methods described herein, the volumetric flow rate of the N extruders can be varied to vary the amount of each polymer in each bundle. For example, when the systems and method include three extruders, the volumetric flow rate can be adjusted by the processor such that the resulting bundles comprise from 1-99% of the first polymer, from 1-99% of the second polymer, and from 1-99% of the third polymer. For example, the resulting bundles may comprise from 1-60% of the first polymer, from 1-60% of the second polymer, and from 1-60% of the third polymer. For example, the filaments comprising the first polymer may be 50% of the filaments in the bundle, the filaments comprising the second polymer may be 25% of the filaments in the bundle, and the filaments comprising the third polymer may be 25% of the filaments in the bundle. When the systems and methods include two extruders, the volumetric flow rate can be adjusted by the processor such that the resulting bundles comprise from 1-99% of the first polymer and from 1-99% of the second polymer. For example, the resulting bundle may comprise from 1-75% of the first polymer and from 1-75% of the second polymer. In some implementations, the resulting bundle may comprise 50% of the first polymer and 50% of the second polymer. In other examples, the filaments in the first, second, and third bundle can respectively, in %, be 10:10:80, 10:20:70, 10:30:60, 10:40:50, 20:10:70, 20:20:60, 20:30:50, 20:40:40, 30:10:60, 30:20:50, 30:30:40, 40:10:50, 40:20:40, 40:30:30, and the like. When the systems and methods include two extruders, the volumetric flow rate can be adjusted by the processor such that the resulting bundles comprise from 1-99% of the first polymer and from 1-99% of the second polymer. For example, the resulting bundle may comprise from 1-75% of the first polymer and from 1-75% of the second polymer. In some implementations, the resulting bundle may comprise 50% of the first polymer and 50% of the second polymer.

According to some implementations, the polymer of the filaments may be solution dyed polymer. In some implementations, the solution dyed polymer filaments are space dyed after processing (also referred to as “over dying”). And, in other implementations, the filaments are not solution dyed and are space dyed or dyed regularly after processing. A solution dyed polymer has coloring agent added prior to filament formation out of the spinneret. A space dyed polymer has a coloring agent that is added to the filament after formation out of the spinneret.

Dyability characteristic refers to a filament's affinity to absorb a dye under the same processing conditions. For example, non-solution-dyed filaments may appear white after spinning due to the lack of presence of dye molecules, pigments, or other molecules that would provide a different color than the material substrate. When subjected to a dyeing process, for example PET using disperse dyes, a molten stream formed with a deep dye PET would have a darker color saturation than a molten stream produced with a traditional PET.

In some implementations of the systems and method described above, the N extruders comprise a first extruder comprising a first polymer capable of absorbing a first dye and a second extruder comprising a second polymer capable of absorbing a second dye. The first dye and/or second dye may comprise, for example disperse dyes, acid dyes, cationic dyes, azoic dyes, sulfur dyes, and/or mordant dyes. In certain embodiments, the first dye and the second dye are different. In additional implementations, the N extruders comprise a third extruder comprising a third polymer capable of absorbing a third dye. The third dye may be different from one or both of the first and second dye. For example, the third dye may comprise disperse dyes, acid dyes, cationic dyes, azoic dyes, sulfur dyes, and/or mordant dyes.

For example, in some implementations, the first polymer comprises one or more polyamide polymers. A polyamide is defined as a synthetic linear polymer whose repeating unit contains amide functional groups, wherein these amide functional groups are integral members of the linear polymer chain.

In some embodiments of any of the aspects described herein, the polyamide may have been formed by condensation polymerization of a dicarboxylic acid and a diamine. Representative examples of such dicarboxylic acids include terephthalic acid, isophthalic acid, 2,6-napthalene dicarboxylic acid, 3,4′-diphenylether dicarboxylic acid, hexahydrophthalic acid, 2,7-naphthalenedicarboxylic acid, phthalic acid, 4,4′-methylenebis (benzoic acid), oxalic acid, malonic acid, succinic acid, methyl succinic acid, glutaric acid, adipic acid, 3-methyladipic acid, pimelic acid, suberic acid, azelaic acid, sebacic acid, 1,11-undecanedicarboxylic acid, 1,10-dodecanedicarboxylic acid, 1,12-dodecanedicarboxylic acid, hexadecanedioic acid, docosanedioic acid, tetracosanedioic acid, 1,4-cyclohexanedicarboxylic acid, 1,3-cyclohexanedicarboxylic acid, 1,2-cyclohexanediactic acid, fumaric acid, and maleic acid. Representative examples of such diamines include ethylene diamine, tetramethylene diamine, hexamethylene diamine, 1,9-nonanediamine, 2-methyl pentamethylene diamine, trimethyl hexamethylene diamine (TMD), m-xylylene diamine (MXD), and 1,5-pentanediamine.

In some embodiments of any of the aspects described herein, the polyamide may have been formed by condensation polymerization of an amino acid (such as 11-aminoundecanoic acid) or ring-opening polymerization of a lactam (such as caprolactam or @-aminolauric acid).

Representative examples of polyamides as may be used in the present disclosure include: aliphatic polyamides such as polyamide 6, polyamide 11, polyamide 12, polyamide 46, polyamide 410, polyamide 4T, polyamide 510, polyamide D6, polyamide DT, polyamide DI, polyamide 66, polyamide 610, polyamide 612, polyamide 6T, polyamide 6I, polyamide MXD6, polyamide 9T, polyamide 1010, polyamide 10T, polyamide 1212, polyamide 12T, polyamide PACM12, polyamide TMDT, polyamide 611, and polyamide 1012; polyphthalimides such as polyamide 6T/66, polyamide LT/DT, and polyamide L6T/6I; and aramid polymers.

In some particular embodiments, the first polymer comprises polyamide 6,6. In other particular embodiments, the first polymer comprises polyamide 6.

In any of the aspects described herein, the polyamide polymer can absorb a first dye. For example, in some embodiments, the first dye comprises one or more acid dyes. Acid dyes are water-soluble anionic dyes that are applied to fibers using neutral to acid dye baths. Attachment to the fiber is attributed, at least partially, to salt formation between anionic groups in the dyes and cationic groups in the fiber. In some embodiments, the acid dye may be chosen from a leveling acid dye, a milling dye, or a metal complex acid dye. In some embodiments, the acid dye is chosen from an anthraquinone type due, an azo dye, or a triarylmethane dye. Representative examples of acid dyes which may be used in the present disclosure include, but are not limited to, Acid Yellow 7, Acid Yellow 17, Acid Yellow 23, Acid Yellow 34, Acid Yellow 36, Acid Yellow 40, Acid Yellow 42, Acid Yellow 49, Acid Yellow 73, Acid Yellow 99, Acid Yellow 127, Acid Yellow 129, Acid Yellow 151 Acid Orange 3, Acid Orange 7, Acid Orange 8, Acid Orange 10, Acid Orange 24, Acid Orange 52, Acid Orange 60, Acid Orange 74, Acid Orange 116, Acid Orange 156, Acid Red 1, Acid Red 4, Acid Red 14, Acid Red 50, Acid Red 52, Acid Red 73, Acid Red 87, Acid Red 88, Acid Red 92, Acid Red 94, Acid Red 99, Acid Red 114, Acid Red 119, Acid Red 131, Acid Red 151, Acid Red 249, Acid Red 266, Acid Red 299, Acid Red 337, Acid Violet 1, Acid Violet 3, Acid Violet 7, Acid Violet 12, Acid Violet 17, Acid Violet 19, Acid Violet 43, Acid Violet 48, Acid Violet 49, Acid Violet 90, Acid Green 1, Acid Green 3, Acid Green 9, Acid Green 16, Acid Green 20, Acid Green 25, Acid Green 92, Acid Brown 14, Acid Brown 44, Acid Brown 97, Acid Brown 98, Acid Blue 1, Acid Blue 7, Acid Blue 9, Acid Blue 15, Acid Blue 25, Acid Blue 40, Acid Blue 45, Acid Blue 62, Acid Blue 80, Acid Blue 83, Acid Blue 90, Acid Blue 92, Acid Blue 113, Acid Blue 145, Acid Blue 158, Acid Blue 185, Acid Black 1, Acid Black 2, Acid Black 24, Acid Black 52, Acid Black 58, Acid Black 60, Acid Black 62, Acid Black 107, Acid Black 131, Acid Black 132, Acid Black 172, and Acid Black 194.

In addition, the second polymer comprises one or more polyester polymers. A polyester is defined as a synthetic linear polymer whose repeating units contain ester functional groups, wherein these ester functional groups are integral members of the linear polymer chain.

Typical polyesters as used in the present disclosure may be formed by condensation of a dicarboxylic acid and a diol. Representative examples of such dicarboxylic acids include terephthalic acid, isophthalic acid, 2,6-naphthalene dicarboxylic acid, 3,4′-diphenylether dicarboxylic acid, hexahydrophthalic acid, 2,7-napthalene dicarboxylic acid, phthalic acid, 4,4′-methylenebis (benzoic acid), oxalic acid, malonic acid, succinic acid, methyl succinic acid, glutaric acid, adipic acid, 3-methyladipic acid, pimelic acid, suberic acid, azelaic acid, sebacic acid, 1,11-undecanedicarboxylic acid, 1,10-dodecanedicarboxylic acid, 1,12-dodecanedicarboxylic acid, hexadecanedioic acid, docosanedioic acid, tetracosanedioic acid, 1,4-cyclohexanedicarboxylic acid, 1,3-cyclohexanedicarboxylic acid, 1,2-cyclohexanediacetic acid, fumaric acid, and maleic acid. Representative examples of such diols include monoethylene glycol, diethylene glycol, triethylene glycol, poly (ethylene ether) glycols, 1,3-propanediol, 1,4-butanediol, poly (butylene ether) glycols, pentamethylene glycol, 1,6-hexanediol, 1,8-octanediol, 1,10-decanediol, 1,12-dodecanediol, 1,14-tetradecanediol, 1,16-hexadecanediol, cis-1,4-cyclohexanedimethanol, and trans-1,4-cyclohexanedimethanol.

Representative examples of polyesters include poly (ethylene terephthalate) (PET), poly (trimethylene terephthalate) (PTT), poly (butylene terephthalate) (PBT), poly (ethylene isophthalate), poly (octamethylene terephthalate), poly (decamethylene terephthalate), poly (pentamethylene isophthalate), poly(butylene isophthalate), poly (hexamethylene isophthalate), poly (hexamethylene adipate), poly (pentamethylene adipate), poly (pentamethylene sebacate), poly (hexamethylene sebacate), poly (1,4-cyclohexylene terephthalate), poly (1,4-cyclohexylene sebacate), poly (ethylene terephthalate-co-sebacate), and poly (ethylene-co-tetramethylene terephthalate).

In particular embodiments, the second polymer comprises polyethylene terephthalate.

In any of the aspects described herein, the second, polyester polymers can absorb a second dye. In some embodiments, the second polymers cannot absorb the first dye. In some embodiments of any of the aspects described herein, the second dye comprises one or more disperse dyes. Disperse dyes have low solubility in water, typically less than 1 mg/L, and are applied to the fibers as an extremely fine suspension. Upon attachment, the particles dissolve, and owing to their low molecular weight, migrate throughout. Disperse dyes are typically azo dyes or anthroquinone dyes. Representative examples of disperse dyes which may be used in the present disclosure include, but are not limited to, Disperse Yellow 1, Disperse Yellow 3, Disperse Yellow 5, Disperse Yellow 23, Disperse Yellow 42, Disperse Yellow 49, Disperse Yellow 54, Disperse Yellow 64, Disperse Yellow 82, Disperse Yellow 86, Disperse Yellow 163, Disperse Yellow 184, Disperse Yellow 211, Disperse Yellow 218, Disperse Yellow 224, Disperse Orange 3, Disperse Orange 25, Disperse Orange 29, Disperse Orange 30, Disperse Orange 37, Disperse Orange 41, Disperse Orange 44, Disperse Orange 73, Disperse Orange 76, Disperse Red 1, Disperse Red 4, Disperse Red 5, Disperse Red 15, Disperse Red 17, Disperse Red 50, Disperse Red 54, Disperse Red 55, Disperse Red 60, Disperse Red 65, Disperse Red 73, Disperse Red 82, Disperse Red 86, Disperse Red 91, Disperse Red 135, Disperse Red 153, Disperse Red 167, Disperse Red 177, Disperse Red 179, Disperse Red 184, Disperse Red 319, Disperse Red 338, Disperse Red 359, Disperse Violet 1, Disperse Violet 4, Disperse Violet 26, Disperse Violet 28, Disperse Violet 31, Disperse Violet 48, Disperse Violet 91, Disperse Green 9, Disperse Brown 1, Disperse Blue 3, Disperse Blue 7, Disperse Blue 26, Disperse Blue 27, Disperse Blue 35, Disperse Blue 55, Disperse Blue 56, Disperse Blue 60, Disperse Blue 64, Disperse Blue 73, Disperse Blue 79, Disperse Blue 87, Disperse Blue 102, Disperse Blue 165, Disperse Blue 183, Disperse Blue 281, Disperse Blue 291, and Disperse Black 9.

In certain implementations, for example, the first polymer comprises a polyamide, the second polymer comprises a PTT, and the third polymer comprises a PTT. The polyamide polymer absorbs an acid dye but the PTT does not, which leaves the PTT undyed in response to an acid dye being applied to the bundle of filaments comprising the polyamide and PTT polymers. As another example, a disperse dye may be applied to a bundle of filaments comprising the polyamide and PTT polymers, which is absorbed by both polymers but at different levels, providing tonal or chromatic differences. An acid dye may also be applied to this bundle of filaments, which would be absorbed by only the polyamide filaments and could lead to further tonal or chromatic differences.

In some implementations of the systems and methods described above, the dye level of the first, second, and/or third polymer may be different from each other. For example, the first polymer may have an affinity for dyes having a bright deep shade, the second polymer may have an affinity for dyes having a light dye shade, and the third polymer may have an affinity for cationic dyes. Accordingly, bundles may be produced containing tonal and chromatic differences.

Luster refers to the amount of refracted light from a material's surface. In certain implementations, each of the N extruders may comprise a polymer having a luster chosen from clear, bright, dull, semi-dull, extra dull, or super dull. For example, in some implementations, the N extruders may comprise a first extruder comprising a first polymer having a first luster type and a second extruder comprising a second polymer having a second luster type. The first luster type and the second luster type may be the same or may be different. For example, the first luster type may be chosen from clear, bright, dull, semi-dull, extra dull, or super dull, and the second luster type may be chosen from clear, bright, dull, semi-dull, extra dull, or super dull, wherein the first luster type and second luster type are different. In some implementations, a third extruder comprising a third polymer having a third luster type may be included. In certain implementations, the third luster type is different than the first luster type and the second luster type. In this regard, the system may produce a bundle of filaments exhibiting a luster effect that is varied along the length of the bundle of filaments and/or within a radial cross section of the bundle of filaments.

In some implementations, the luster of a polymer may be modified by the addition of a delustering agent. A delustering agent is an additive configured to change the refractivity index of a polymer. Some examples of delustering agents include titanium oxide, kaolin, talc, calcium carbonate, silica, zinc sulfide, and zinc white. In one implementation, the delustering agent comprises titanium oxide.

In one implementation, the first luster type may be full dull, the second luster type may be semi dull, and the third luster type may be full bright. Accordingly, the resulting bundle of filaments will contain a unique color perception compared to a bundle of filaments containing a single luster type. Various combinations of the first, second, and optionally third luster types are included in the present disclosure.

In some implementations, a combination of the above techniques may be used to achieve a desired result. For example, various dye levels and lusters of each of the polymers in the N extruders may be included to produce a bundle of filaments exhibiting a color, hue, luster, and/or dyability characteristic effect that is varied along the length of the bundle of filaments and/or within a radial cross section of the bundle of filaments. Other combinations can be used according to the desired result.

By increasing the denier per filament of filaments in one or more bundles of filaments of the yarn, the color from that group of filaments is visibly more prevalent in the yarn. If other process controls are the same, increasing the speed of the spin pump increases the volumetric flow rate of the molten polymer through the spinneret in fluid communication with the spin pump, and an increased volumetric flow rate through the spinneret increases the average denier per filament of the filaments spun through the spinneret. Conversely, decreasing the speed of the spin pump decreases the volumetric flow rate of the molten polymer through the spinneret in fluid communication with the spin pump, and a decreased volumetric flow rate through the spinneret reduces the average denier per filament of the filaments spun through the spinneret. Thus, the average denier per filament of the filaments in each filament bundle can be increased or decreased by changing the speed (and thus the volumetric flow rates) of the respective pump(s) in communication with the spinnerets through which the filaments in each bundle are spun. Increasing and decreasing the speed of at least one or more pumps can also be varied according to a certain frequency and amplitude, in some implementations, creating portions of a length of the bundle that have a higher DPF than other portions of the length.

The processor 110 is configured to execute computer readable instructions that cause the processor 110 to adjust the volumetric flow rate of the molten polymer pumped by each spin pump 104a1, 104a2, 104a3, 104b1, 104b2, 104b3 to achieve a ratio of the polymers to be included in the first yarn and the second yarn produced by spin stations 106a, 106b, respectively. Adjusting the volumetric flow rate of the polymer displaced by each of the extruders 102a, 102b, 102c by each spin pump 104a1, 104a2, 104a3, 104b1, 104b2, 104b3 adjusts the ratio of the polymers in each yarn, which changes the overall color, hue, luster, and/or dyability characteristic of the yarn. The ratio of the polymers to be included in each yarn refers to the ratio of colors, hues, lusters, and/or dyability characteristics from each extruder 102a, 102b, 102c that are included in each yarn. A first ratio of the polymers to be included in the first yarn may or may not be different from a second ratio of the polymers to be included in the second yarn. Each yarn includes a first bundle of filaments 114a1, 114b1 having the color, hue, luster, and/or dyability characteristic of the polymer in the first extruder 102a, a second bundle of filaments 114a2, 114b2 having the color, hue, luster, and/or dyability characteristic of the polymer in the second extruder 102b, and a third bundle of filaments 114a3, 114b3 having the color, hue, luster, and/or dyability characteristic of the polymer in the third extruder 102c. When the bundles of filaments 114a1, 114a2, 114a3 from the first spin station 106a are brought together into the first yarn and the bundles of filaments 114b1, 114b2, 114b3 from the second spin station 106b are brought together into the second yarn, the bundles of filaments 114a1, 114a2, 114a3, 114b1, 114b2, 114b3 in each yarn provide a color, luster, hue and/or dyability characteristic appearance that depends on the relative linear densities, or titer (e.g., also referred to as “denier per filament”, “denier per fiber” or “DPF”)) per filament, of each filament in each bundle 114a1, 114a2, 114a3, 114b1, 114b2, 114b3.

Thus, the overall color, hue, luster, and/or dyability characteristic of each yarn can be altered by altering the relative denier per filament of the filaments from each extruder 102a, 102b, 102c along the length of the filaments. The desired denier per filament of the filaments in each filament bundle 114a1, 114a2, 114a3, 114b1, 114b2, 114b3 depends on the volumetric flow rate through each pump 104a1, 104a2, 104a3, 104b1, 104b2, 104b3. For example, if the desired overall color for the first yarn is the color of the polymer in extruder 102a, then the processor 110 adjusts the volumetric flow rate of the pumps 104a1, 104a2, 104a3 such that the denier per filament of the filaments in bundle 114al is larger than the denier per filament of the filaments in bundles 114a2 and 114a3. This combination results in the appearance that the first yarn has the color of the polymer in extruder 102a because the filaments with the smaller denier are not as prominent. For example, if the total volumetric flow rate is 360 cm³/minute for one of the spin stations and there are three spin pumps for each spin station, then a baseline volumetric flow rate for each pump in that spin station is 120 cm³/minute. If the desired overall color for the yarn from that spin station is the color of the polymer in extruder 102a, then the volumetric flow rate of the pump in fluid communication with extruder 102a is increased by more than 40% of the baseline volumetric flow rate (e.g., increase from 120 cm³/minute to greater than 168 cm³/minute), and the volumetric flow rates of the other pumps are decreased. For example, if the total volumetric flow rate through the spin station is to remain constant and the volumetric flow rate of the pump in fluid communication with extruder 102a is increased to 220 cm³/minute, then the volumetric flow rates of the other pumps may be decreased to 70 cm³/minute each.

As another example, if the desired overall color for the first yarn is a mixture of the colors of the polymers in extruders 102a and 102b, then the processor 110 adjusts the volumetric flow rate of the pumps 104a1, 104a2, 104a3 such that the denier per filament of the filaments in bundles 114al and 114a2 are larger than the denier per filament of the filaments in bundle 114a3. This combination results in the appearance that the first yarn has a color that is a mixture of the colors of the polymers in extruder 102a and 102b because the filaments with the smaller denier are not as prominent. For example, if the total volumetric flow rate is 360 cm³/minute for one of the spin stations and there are three spin pumps for each spin station, then a baseline volumetric flow rate for each pump in that spin station is 120 cm³/minute. If the desired overall color for the yarn from that spin station is achieved by using an equal mixture of the colors of the polymers in extruders 102a and 102b, then the volumetric flow rates of the pumps in fluid communication with the extruders 102a and 102b are increased by more than 40% of the baseline volumetric flow rate (e.g., increase from 120 cm³/minute to greater than 168 cm³/minute), and the volumetric flow rate of the other pump is decreased. For example, if the total volumetric flow rate through the spin station is to remain constant and the volumetric flow rates of the pumps in fluid communication with extruders 102a and 102b are increased to 170 cm³/minute, then the volumetric flow rate of the other pump is decreased to 20 cm³/minute.

As a third example, if the desired overall color of the first yarn is an even mixture of the colors from all three extruders 102a, 102b, 102c, then the processor 110 adjusts the volumetric flow rate of the pumps 104a1, 104a2, 104a3 to the baseline volumetric flow rate such that the denier per filament of the filaments in bundles 114a1, 114a2, and 114a3 are the substantially same.

This system 100 allows for yarns to be made having more colors, hues, lusters, and/or dyability characteristics than the number of extruders providing each color, hue, luster, and/or dyability characteristic. For example, if the extruders 102a-102c each have polymers solution dyed red, blue, and yellow, various ratios of these polymers yield yarns having these colors and combinations thereof, such as purple, orange, and green.

For example, in some implementations, the speed of each spin pump 104a1, 104a2, 104a3, 104b1, 104b2, 104b3 is at least 2 RPM. And, in certain implementations, a maximum speed of each spin pump 104a1, 104a2, 104a3, 104b1, 104b2, 104b3 is 30 RPM. However, in other implementations, the maximum speed of each spin pump may be higher.

In addition, a sum of the volumetric flow rates extruded from each extruder by the spin pumps paired with the respective extruder varies 0 to +5%. For example, the total volumetric flow rate being extruded from extruder 102a is the sum of the volumetric flow rate being extruded by pump 104al and the volumetric flow rate being extruded by pump 104b1. Similarly, the total volumetric flow rate being extruded from extruder 102b is the sum of the volumetric flow rate being extruded by pump 104a2 and the volumetric flow rate being extruded by pump 104b2. And, the total volumetric flow rate being extruded from extruder 102c is the sum of the volumetric flow rate being extruded by pump 104a3 and the volumetric flow rate being extruded by pump 104b3. These total volumetric flow rates are constant or do not vary more than +5%, according to some implementations. Accordingly, in some implementations, the sum of the areas of radial cross-sections of all filaments in a radial cross-section of the yarn varies by +5% or less. However, the average denier of the yarn from the first spin station 106a may be different from the average denier of the yarn from the second spin stations 106b.

In other implementations, the volumetric flow rate displaced by each pump that is paired with a particular extruder is not limited relative to the volumetric flow rate displaced by the other pumps unless there is a desire to maintain a constant throughput of the extruder with which the pumps are paired.

In some implementations, the instructions also cause the processor 110 to determine the volumetric flow rate of each polymer to be pumped by each spin pump 104a1, 104a2, 104a3, 104b1, 104b2, 104b3 to achieve the desired ratio and generate the instructions to the spin pumps 104a1, 104a2, 104a3, 104b1, 104b2, 104b3 based on the volumetric flow rate determinations. However, in other implementations, the volumetric flow rate for each spin pump 104a1, 104a2, 104a3, 104b1, 104b2, 104b3 may be determined by another processor or otherwise input into the system 100. In addition, in other implementations, the instructions to the spin pumps 104a1, 104a2, 104a3, 104b1, 104b2, 104b3 may be generated by another processor or otherwise input into the system 100.

In various embodiments, the volumetric flow rate extruded by each of the spin pumps of a respective spin station is greater than zero, and the volumetric flow rate of at least one pump in each spin station is variable by more than +40% of a baseline volumetric flow rate, wherein the baseline volumetric flow rate is equal to a total volumetric flow rate through the spin station divided by N. The volumetric flow rate can be varied such that the flow of the polymer streams through the spinnerets of the respective spin station are continuous and support continuous filament formation. The variation in the volumetric flow rate of the polymer may be based on, but is not limited to, the type of polymer, a size and/or shape of the capillaries of the spinneret, the temperature of the polymer, and the denier per filament of the filaments spun from that spinneret.

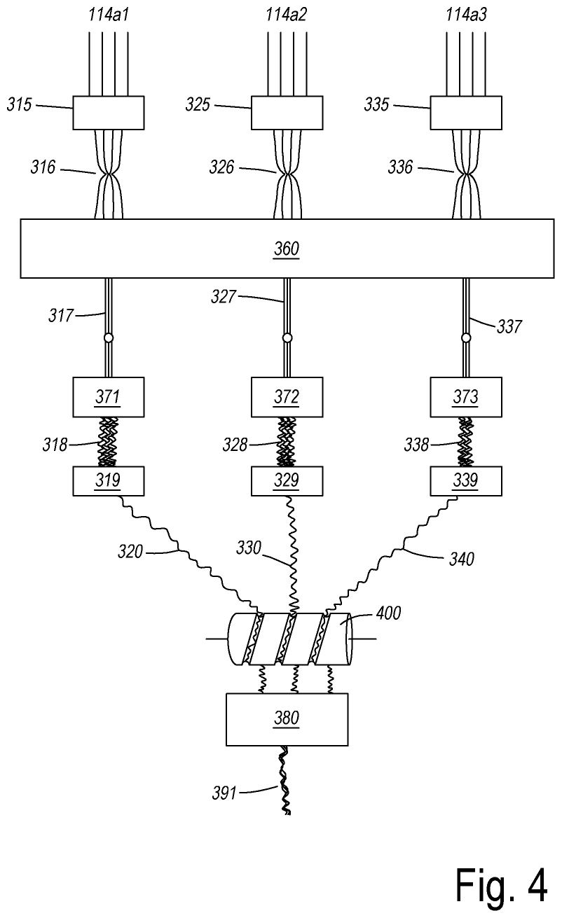

In some implementations, the computer readable instructions are stored on a computer memory that is in electrical communication with the processor 110 and disposed near the processor (e.g., on the same circuit board and/or in the same housing). And, in other implementations, the computer readable instructions are stored on a computer memory that is in electrical communication with the processor but is remotely located from the processor. FIG. 4, which is described below, illustrates an example computing system that includes a processor 1021, which can include processor 110. The system in FIG. 4 may be used by system 100, for example.

The radial cross-sectional shape of each filament in any of the first through fourth aspects may be the same as the other filaments or different, e.g. depending on the shapes of the openings defined by the spinneret through which each filament is spun. For example, the filaments may have radial cross sections that are circular, trilobal, fox, or other suitable shape. In addition, the filaments may be solid or define at least one hollow void. Similarly, the size of the spinneret openings may be the same or different, depending on the desired denier per filament for each filament.

In addition, in some implementations, a speed at which the system 100 is run (e.g., velocity at which yarn produced by the system 100 can be made) may be adjusted based on the variation of the DPF of the filaments in each filament bundle 114a1, 114a2, 114a3, 114b1, 114b2, 114b3 to prevent the filaments with a lower DPF from breaking. Examples of other factors that may be considered in selecting the system speed include, but are not limited to, polymer temperature, polymer type, capillary size and shape of the spinnerets, volumetric flow rates, and/or quenchability.

The speed at which the system 100 is run also may be increased or decreased based on the desired appearance. And depending on the operating parameters of the system, a change in speed may not affect the appearance of the yarn.

In some implementations, the instructions also cause the processor 110 to adjust the timing of the volumetric flow rate changes and hence adjust the corresponding denier and/or color changes in the yarn. For example, the following description is for a sequence of steps performed by the processor 110. At step 1, the instructions cause the spin pump 104al to be at a higher speed (for example, 50% of maximum speed) and the spin pump 104a2 and 104a3 to be at a lower speed (for example, each at 25% of maximum speed) for an initial ×1 seconds (for example, ×1 is 1 sec, 2 secs, 3 secs, 4, secs, 5 secs, 6 secs, 7 secs, 8 secs, and so on). The amount of time that a specific combination of spin pump speeds is held determines the length of the particular color pattern produced by the combination of the spin pump speeds in the yarn. After the initial ×1 seconds, at step 2, the instructions cause the processor 110 to change the speeds of the pumps such that the spin pumps 104al and 104a2 are at a lower speed (for example 25% of maximum speed) and the spin pump 104a3 is at a higher speed (for example 50% of maximum speed) for ×2 seconds. In some embodiments, ×1=×2, and in other embodiments, ×1 is different from ×2. At step 3, after the ×2 seconds elapses, the instructions cause the processor 110 to change the speeds of the pumps such that the spin pumps 104al and 104a3 are at a lower speed (for example at 25% of maximum speed) and spin pump 104a2 is at a higher speed (for example at 50% of maximum speed) for ×3 seconds. Again, ×3 can be equal to ×1 and/or ×2. In other embodiments, ×3 can be different from ×1 and/or ×2. After ×3 seconds, at step 4, the instructions cause the processor 110 to change the speeds of the pumps such that the spin pumps 104a1, 104a2, 104a3 are at the same speed (for example, each at 33.33% of the maximum speed). The above sequence or a variation thereof is repeated to produce the desired color variation in the yarn.

In another example implementation, the instructions cause the processor 110 to randomize the above steps to produce random color variation in the yarn. For example, an internal clock associated with the processor 110 selects an overall timer with a first random number greater than 0 and to and including y secs (for example, y can be 5 secs, 6 secs, 7 secs, 7.5 secs, 8 secs, 9 secs, 10 secs, and so on). Then the instructions cause the processor 110 to select a second set of random numbers for each of ×1, ×2, ×3, and ×4 in step 1-4 above (for example, ×1=2 secs, ×2=3 secs, ×3=1 sec, ×4=2 sec). As the instructions cause the processor to execute steps 1-4, the overall timer based on the first random number (for example, y=7.5 secs) decides when the process is reset. In the above example, when the time associated with the overall timer elapses, the instructions cause the processor 110 to terminate step 4 at ×4=1.5 secs and restart the process steps from step 1 to step 4. In other embodiments, the steps 1-4 described above can be executed by the processor 110 in any order. The processor can also randomize the sequence of steps 1-4. In other embodiments, the speed of the pumps 104a1, 104a2, 104a3 for each of the above steps is randomized. For example, at step 1, the instructions cause the processor 110 to change the speed of the pumps such that pumps 104al and 104a2 are at a random lower speed (for example, at 20% of maximum speed and 28% maximum speed respectively) and spin pump 104c is at a higher speed (for example, at 52% of maximum speed).

Filaments produced using the system 100 have better wear properties because the color, luster, and/or dye extends through the full mass of the filament. Having the color, luster, and/or dye extend through the entire filament also improves the appearance of cut pile in carpets. In addition, the system 100 is faster and less expensive than prior art systems because the average denier of the yarn can be kept substantially constant and the pumps 104a1, 104a2, 104a3, 104b1, 104b2, 104b3 do not have to stop to allow for changes in the color of the yarn produced. This system 100 also produces less waste by avoiding the need to stop and start at each color change.

For solution dyed filaments, each filament in the yarn has a color, luster, hue and/or dyability characteristic from an external surface to a center thereof, and for at least a subset of the plurality of filaments, the denier per filament of each filament within the subset varies along a length of the filament.

In some implementations, the yarn is bulked continuous filament (BCF) yarn. The yarn is made according to any of the processes described above and/or by any of the systems described above. In addition, some implementations include a carpet that includes pile made with this yarn.

The yarn may be a bulked continuous filament (BCF) yarn that may be (1) extruded and drawn in a continuous operation, (2) extruded, drawn, and textured in a continuous operation, (3) extruded and taken up in one step and is then later unwound, drawn, and textured in another step, or (4) extruded, drawn, and textured in one or more operations.

Furthermore, in some implementations, the BCF yarn could be used as yarn in carpet or in apparel, for example.

In addition, in some implementations, carpet having changing colors, such as the carpet described above, can be made from one continuous BCF yarn, instead of having to stop the process to switch out yarn having a different color.

The bundles 114a1, 114a2, 114a3, 114b1, 114b2, 114b3 produced by system 100 in FIG. 1 can be drawn separately by drawing device (not shown in FIG. 1), which is one or more godets, after the spinning process to their final denier per filament, assuming that the filaments in the bundles 114a1, 114a2, 114a3, 114b1, 114b2, 114b3 are not subject to breakage due to their denier per filament, radial cross-sectional shape, or otherwise. In other implementations, the drawing device can also include a draw point localizer.

In some embodiments of any of the first through fourth aspects, the DPF of the filaments in each of the bundles are equal. However, in other embodiments, at least some of the filaments in one bundle may have a different DPF than the other filaments in the bundle. Or, in some embodiments, the filaments in one bundle may have the same DPF as other filaments in the bundle but the DPF of those filaments may be different from the DPF of the filaments in another bundle. And, in some embodiments, the number of filaments in the bundles are equal. And, in other embodiments, the number of filaments in each bundle may differ.

It is remarked that where notice is made of different or varying colors or hue, at least a color or hue difference as expressed with a Delta E value of 1.0 is preferred. Even better the difference or variation at least encompasses a color or hue difference as expressed by Delta E of at least 5.0 or at least 10.0. Delta E is a measure of change in visual perception of two given colors.

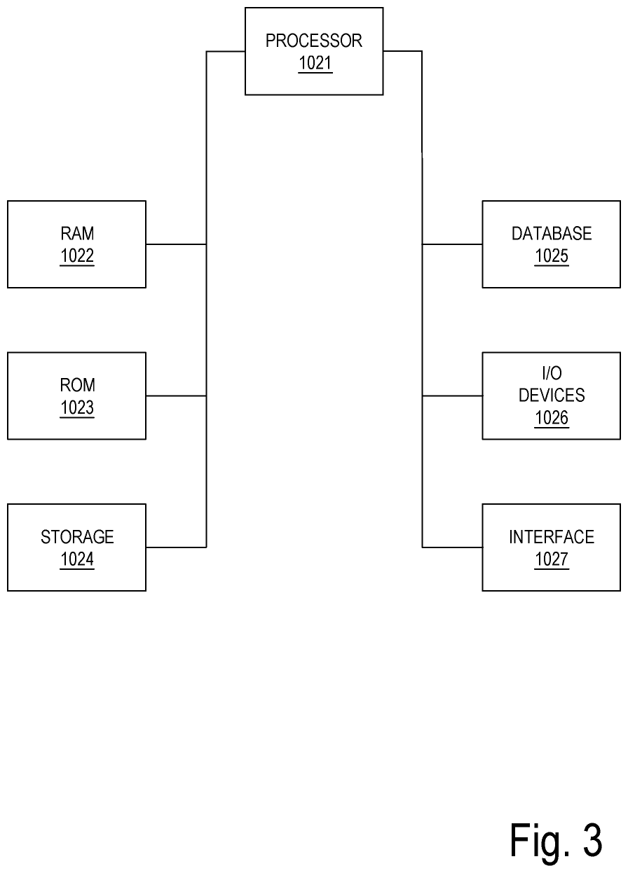

FIG. 3 illustrates an example computing device that can be used for controlling the pumps of the system 100. As used herein, “computing device” or “computer” may include a plurality of computers. The computers may include one or more hardware components such as, for example, a processor 1021, a random access memory (RAM) module 1022, a read-only memory (ROM) module 1023, a storage 1024, a database 1025, one or more input/output (I/O) devices 1026, and an interface 1027. All of the hardware components listed above may not be necessary to practice the methods described herein. Alternatively and/or additionally, the computer may include one or more software components such as, for example, a computer-readable medium including computer executable instructions for performing a method associated with the example embodiments. It is contemplated that one or more of the hardware components listed above may be implemented using software. For example, storage 1024 may include a software partition associated with one or more other hardware components. It is understood that the components listed above are examples only and not intended to be limiting.

Processor 1021 may include one or more processors, each configured to execute instructions and process data to perform one or more functions associated with a computer for producing at least one bundle of filaments and/or at least one yarn.

Processor 1021 may be communicatively coupled to RAM 1022, ROM 1023, storage 1024, database 1025, I/O devices 1026, and interface 1027. Processor 1021 may be configured to execute sequences of computer program instructions to perform various processes. The computer program instructions may be loaded into RAM 1022 for execution by processor 1021.

RAM 1022 and ROM 1023 may each include one or more devices for storing information associated with operation of processor 1021. For example, ROM 1023 may include a memory device configured to access and store information associated with the computer, including information for identifying, initializing, and monitoring the operation of one or more components and subsystems. RAM 1022 may include a memory device for storing data associated with one or more operations of processor 1021. For example, ROM 1023 may load instructions into RAM 1022 for execution by processor 1021.

Storage 1024 may include any type of mass storage device configured to store information that processor 1021 may need to perform processes consistent with the disclosed embodiments. For example, storage 1024 may include one or more magnetic and/or optical disk devices, such as hard drives, CD-ROMs, DVD-ROMs, or any other type of mass media device.

Database 1025 may include one or more software and/or hardware components that cooperate to store, organize, sort, filter, and/or arrange data used by the computer and/or processor 1021. For example, database 1025 may store computer readable instructions that cause the processor 1021 to adjust the volumetric flow rate of the polymers pumped by each spin pump to achieve a ratio of the polymers to be included in a yarn that includes the bundles of filaments spun from the spin station. It is contemplated that database 1025 may store additional and/or different information than that listed above.

I/O devices 1026 may include one or more components configured to communicate information with a user associated with computer. For example, I/O devices may include a console with an integrated keyboard and mouse to allow a user to maintain a database of digital images, results of the analysis of the digital images, metrics, and the like. I/O devices 1026 may also include a display including a graphical user interface (GUI) for outputting information on a monitor. I/O devices 1026 may also include peripheral devices such as, for example, a printer for printing information associated with the computer, a user-accessible disk drive (e.g., a USB port, a floppy, CD-ROM, or DVD-ROM drive, etc.) to allow a user to input data stored on a portable media device, a microphone, a speaker system, or any other suitable type of interface device.

Interface 1027 may include one or more components configured to transmit and receive data via a communication network, such as the Internet, a local area network, a workstation peer-to-peer network, a direct link network, a wireless network, or any other suitable communication platform. For example, interface 1027 may include one or more modulators, demodulators, multiplexers, demultiplexers, network communication devices, wireless devices, antennas, modems, and any other type of device configured to enable data communication via a communication network.

FIG. 4 illustrates a schematic diagram of optional post-spinning processes for a portion of the bundle of filaments 114a1, 114a2, 114a3 from the spinning system in FIG. 1. These optional post-spinning processes enhance the color contributed to the yarn by each bundle of filaments 114a1, 114a2, 114a3. FIG. 4 illustrates these processes with respect to the bundles of filaments 114a1, 114a2, 114a3, but these processes may be used with other groups of bundles of filaments, such as 114b1, 114b2, and 114b3. Each process can be used when there are two or more spun filament bundles that have different colors, hues, lusters, and/or dyability characteristics. The processes include (1) tacking spun filaments in at least one bundle separately from the other bundles after spinning and prior to or during the drawing process, (2) texturing tacked spun filaments in at least one bundle separately from the other bundles after the drawing process, and (3) tacking textured and tacked spun filaments in at least one bundle separately from the other bundles and feeding the bundles to a mixing cam that feeds the bundles to a final tacking device for tacking together the bundles into a yarn.

As shown in FIG. 4, each bundle of spun filaments 114a1, 114a2, 114a3 are tacked individually by a tacking device 315, 325, 335 respectively. In other words, each bundle 114a1, 114a2, 114a3 is physically separated from the other bundle and only filaments belonging to the respective bundle are tacked together. The tacking devices 315, 325, 335 are air entanglers. The tacking is done with air entangling every 6 to 155 mm (e.g., 20 to 50 mm). In addition, the tacking devices 315, 325, 335 may use 2 to 6 bar pressure, but the pressure may increase with an increased number of filaments, increased denier per filament, and/or increased speed of filament production.

The tacking devices 315, 325, 335 are air entanglers that use room temperature air for entangling the filaments. In other embodiments, the tacking devices include heated air entanglers (e.g., air temperature is higher than room temperature) or steam entanglers, for example.

The bundles of tacked filaments 316, 326, 336 are drawn to the final titer by drawing device 360, which is a plurality of godets. The godets are each turned at a different speed, according to some embodiments. The draw ratio is typically 1.5 to 4.5. Each filament is drawn to a titer of 2 to 40 titer (or DPF). Three bundles of elongated spun filaments 317, 327, 337 are provided after drawing.

When looking along the axial length of the yarn 391, the position of the filaments originating from bundles 114a1, 114a2, 114a3 are more pronounced in the yarn 391 than if the bundles of filaments 114a1, 114a2, 114a3 had not been individually tacked with tacking devices 315, 325, 335.

In alternative embodiments (not shown in FIG. 4), air entanglement can be applied to one or more of the bundles by turning off or on air to 315, 325, 326. In addition, in other embodiments, air can be applied constantly or in an on/off sequence to get the desired end effect.

And, in yet another embodiment (not shown in FIG. 4), the bundles of spun filaments are first elongated partially before being tacked individually. After the tacking step, the spun, tacked bundles are further elongated to the final denier.

Next, to further enhance the color of each bundle within the yarn, each bundle of tacked and drawn filaments 317, 327, 337 are texturized separately through texturizers 371, 372, 373, respectively. Following this step, bundles 318, 328, 329 of texturized filaments are provided.

The texturizers 371, 372, 373 may apply air, steam, heat, mechanical force, or a combination of one of more of the above to the filaments to cause the filaments to bulk (or crimp/shrink). The bundles 317, 327, 337 are texturized to have a bulk (or crimp or shrinkage) of 5-20%. Texturizing individual bundles of filaments separately, when using bundles with different colors, hues, lusters and/or dyability characteristics, provides a more pronounced color, hue, luster, and/or dyability characteristic along the axial length of the BCF yarn. The filaments that are texturized separately tend to stay more grouped together during the rest of the production steps to make the BCF yarn, which results in the color, hue, luster, and/or dyability characteristic of this bundle of spun filaments being more pronounced along the length of the BCF yarn.

Next, the texturized filaments 318, 328, 338 are provided to an individual color entanglement process prior to the final tacking at tacking device 380. In this individual color entanglement process, the bundles 318, 328, 338 of texturized filaments are fed into separate tacking devices 319, 329, 339 to tack individually each bundle of texturized spun filaments.

Tacking devices 319, 329, 339 are air entanglers that use room temperature air applied at 2 bar to 6 bar pressure, for example, for entangling the filaments every 15 to 155 mm. But the pressure may increase with an increased number of filaments, increased denier per filament, and/or increased speed of filament production. And, in other embodiments, the tacking devices 319, 329, 339 include heated air entanglers (e.g., air temperature is higher than room temperature) or steam entanglers, for example. The tacking may be done more frequently for a specific look desired. For example, with more frequent tacking, the yarn looks less bulky and the color separation is reduced, which results in a more blended look for the colors.

After being individually tacked with tacking devices 319, 329, 339, the bundles 320, 330, 340 are guided to a mixing cam 400. The mixing cam 400 positions bundles tacked by tacking devices 319, 329, 339 relative to each other prior to being tacked together in final tacking device 380. The mixing cam 400 is cylindrical and has an external surface defining a plurality of grooves for receiving and guiding the texturized and tacked bundles.

The mixing cam 400 is rotatable about its central axis or can be held stationary. If rotated, the mixing cam 400 varies which side of the bundles are presented to the tacking jet in the tacking device 380, which affects how the bundles (and filaments therein) are layered relative to each other. In some embodiments, the positions are randomly varied. The speed of rotation can be changed to provide a different appearance in the yarn 391. For example, one or more of the bundles 320, 330, 340 may have a first color on one side of the bundle 320, 330, 340 and a second color on another side of the bundle 320, 330, 340, wherein the sides of the bundle are circumferentially spaced apart but intersected by the same radial plane. It may be desired to have the first color on an exterior facing surface of an arc in a carpet loop in one area of the carpet and the second color on an exterior facing surface of an arc in a carpet loop in another area of the carpet. Rotating the cam 400 may “flip” one or more of the bundles 320, 330, 340 about its axis such that the desired color is oriented on a portion of the outer surface of the yarn 391 such that the desired color is on the exterior facing surface of the arc in the carpet loop. The undesired color for that portion of the carpet is hidden on the inside facing surface of the loop. Rotation of the cam 400 ensures that the filaments that run on the outside of the loop are changing due to a specific mechanical means and not necessarily natural occurrences in downstream processes.

When stationary, the positions of the bundles 320, 330, 340 are directed by the mixing cam 400 to the final tacking device 380 but their relative positions are not varied. In alternative embodiments, the bundles 320, 330, 340 are fed to the tacking device 380 directly or they are fed via a stationary guide disposed between the intermediate tacking devices 319, 329, 339 and the tacking device 380.

The tacked texturized bundles 320, 330, 340 positioned by mixing cam 400 are thereafter tacked together by tacking device 380 into a BCF yarn 391. This tacking is done with air entangling every 12 to 80 mm.

Tacking device 380 is an air entangler that uses room temperature air applied at 2 bar to 6 bar pressure, for example, for entangling the filaments. But the pressure may increase with an increased number of filaments, increased denier per filament, and/or increased speed of filament production. And, in other embodiments, the tacking device 380 includes heated air entanglers (e.g., air temperature is higher than room temperature) or steam entanglers, for example. The bundles 320, 330, 340 are tacked and as such provide a BCF yarn 391 comprising an average of 24-360 filaments of 2 to 40 DPF each. The tacking may be done more frequently for a specific look desired. For example, with more frequent tacking, the yarn looks less bulky and the color separation is reduced, which results in a more blended look for the colors.

The effect of this individual tacking and guidance via a mixing cam cause the colors, hues, lusters, and/or dyability characteristic in the yarn to be more structured and positioned. When such yarn is used as for example, a tufting yarn in a tufted carpet, the positioning of the colored bundles in the yarn cause bundles to be more pronounced in the final carpet surface. The positioning of the color, hue, luster, and/or dyability characteristic in the BCF yarn has as effect that this color, hue, luster, and/or dyability characteristic can be locally more present on the top side of the tuft oriented upwards, away from the backing of the carpet, or hidden at the low side of the tuft oriented towards the backing of the carpet. The effect is the provision of very vivid and pronounced color zones on the carpet.

Various implementations have been described. Nevertheless, it will be understood that various modifications may be made without departing from the spirit and scope of the description. Accordingly, other implementations are within the scope of the following claims.

Disclosed are materials, systems, devices, methods, compositions, and components that can be used for, can be used in conjunction with, can be used in preparation for, or are products of the disclosed methods, systems, and devices. These and other components are disclosed herein, and it is understood that when combinations, subsets, interactions, groups, etc. of these components are disclosed that while specific reference of each various individual and collective combinations and permutations of these components may not be explicitly disclosed, each is specifically contemplated and described herein. For example, if a device is disclosed and discussed every combination and permutation of the device, and the modifications that are possible are specifically contemplated unless specifically indicated to the contrary. Likewise, any subset or combination of these is also specifically contemplated and disclosed. This concept applies to all aspects of this disclosure including, but not limited to, steps in methods using the disclosed systems or devices. Thus, if there are a variety of additional steps that can be performed, it is understood that each of these additional steps can be performed with any specific method steps or combination of method steps of the disclosed methods, and that each such combination or subset of combinations is specifically contemplated and should be considered disclosed.

The terminology used herein is for the purpose of describing particular implementations only and is not intended to be limiting of the disclosure. As used herein, the singular forms “a”, “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

1. A system for producing a bundle of filaments, the system comprising:
N extruders, wherein N is an integer greater than 1, each extruder comprising a polymer having a color, hue, luster, and/or dyability characteristic, the colors, hues, lusters, and/or dyability characteristics of the polymers in the N extruders being different from each other;
wherein a first extruder of the N extruders is configured to extrude a first polymer selected from a group consisting of a polyamide, a polyester, and a polyolefin, and a second extruder is configured to extrude a second polymer selected from a group consisting of a polyamide, a polyester, and a polyolefin, wherein the first polymer and the second polymer are different; and
M spin stations for receiving molten polymer streams from the N extruders, wherein M is an integer of 1 or more, each spin station spinning N bundles of filaments that are combined into a yarn, and each spin station comprising:
N spinnerets through which a plurality of melt-spun filaments are spun from each of the N molten polymer streams received by the spin station; and
N spin pumps upstream of the N spinnerets, wherein each spin pump is in fluid communication and is paired with one of the N extruders, and wherein each spin pump is in fluid communication and is paired with only one spinneret; and
a processor in electrical communication with the N*M spin pumps, the processor being configured to execute computer readable instructions that cause the processor to adjust a volumetric flow rate of the polymers pumped by each spin pump in each spin station to achieve a ratio of the polymers to be included in the yarn that comprises the N bundles of filaments spun from the respective spin station; and
wherein the volumetric flow rate extruded by each of the spin pumps in a respective one of the M spin stations is greater than zero and is variable such that flow of the polymer streams through the spinnerets of the respective spin station is continuous and supports continuous filament formation and wherein the volumetric flow rate of at least one pump in each spin station is variable by greater than ±40% of a baseline volumetric flow rate, the baseline volumetric flow rate being equal to a total volumetric flow rate through the spin station divided by N; and
wherein a number of yarns produced by the system is N.

2. The system of claim 1, wherein the instructions further cause the processor to determine the volumetric flow rate of each polymer to be pumped by each spin pump and generate the instructions to the spin pumps based on the volumetric flow rate determinations.

3. The system of claim 2, wherein the instructions further cause the processor to determine an amount of time during which the determined volumetric flow rate of each polymer is pumped by each spin pump.

4. (canceled)

5. The system of claim 3, wherein the instructions further cause the processor to randomly vary the volumetric flow rate of each polymer to be pumped by each spin pump.

6. The system of claim 5, wherein M is greater than 1 and the system comprises at least a first spin station and a second spin station, wherein the ratio is a first ratio for the first spin station and a second ratio for the second spin station, and wherein a sum of the volumetric flow rates extruded from each extruder by the spin pumps paired with the respective extruder varies 0 to ±5%.

7. (canceled)

8. The system of claim 6, wherein an average denier of each yarn varies by +5% or less along a length of each yarn.

9-23. (canceled)

24. A method to produce at least one bundle of filaments comprising:
providing N streams of molten polymer, wherein N is an integer greater than 1, and each stream has a different color, hue, luster and/or dyability characteristic;
providing M spin stations, wherein M is an integer of 1 or more, each spin station having N plates for receiving the N streams of polymer, N spinnerets, and N spin pumps, each spin pump pumping one of the N streams of polymer to one only one of the N plates, and each of the N plates being in fluid communication with ene only one of the N spinnerets, the N spin pumps being disposed upstream of N plates and N spinnerets, and wherein each spin pump is in fluid communication and is paired with only one plate;
wherein a first stream of the N streams comprises a first polymer selected from a group consisting of a polyamide, a polyester, and a polyolefin, and a second stream comprises a second polymer selected from a group consisting of a polyamide, a polyester, and a polyolefin, wherein the first polymer and the second polymer are different; and
adjusting a volumetric flow rate of each polymer stream pumped to the respective spinneret of the spin station to achieve a ratio of the polymer streams to be included in a yarn, the yarn comprising bundles of filaments spun from the spinnerets of each spin station,
wherein the volumetric flow rate extruded by each spin pump in a respective one of the M spin stations is greater than zero and is variable such that the flow of the polymer streams through the spinnerets of the respective spin station is continuous and supports continuous filament formation and wherein the volumetric flow rate of at least one pump in each spin station is variable by more than ±40%.

25. The method of claim 24, further comprising determining an amount of time during which the determined volumetric flow rate of each polymer is pumped by each spin pump.

26. The method of claim 25, further comprising randomly varying the amount of time during which the determined volumetric flow rate of each polymer is pumped by each spin pump.

27. The method of claim 26, further comprising randomly varying the volumetric flow rate of each polymer to be pumped by each spin pump.

28. The method of claim 27, wherein M is greater than one, and the M spin stations comprise a first spin station and a second spin station, and the ratio is a first ratio for the first spin station and a second ratio for the second spin station, and a sum of the volumetric flow rates extruded from each extruder by the spin pumps paired with the respective extruder varies 0 to ±5%.

29. (canceled)

30. A plurality of bundles of filaments produced using the method of claim 28.

31. (canceled)

32. (canceled)

33. (canceled)

34. A yarn comprising a plurality of bundles of filaments, wherein at least two of the bundles of filaments have different colors, hues, lusters and/or dyability characteristics, and a sum of areas of radial cross-sections of filaments in each respective bundle of filaments varies along a length of the respective bundle of filaments;
wherein the first set of filaments is capable of absorbing a first dye, the first dye chosen from disperse dyes, acid dyes, cationic dyes, azoic dyes, sulfur dyes, mordant dyes, or any combination thereof, wherein the second set of filaments is capable of absorbing a second dye, the second dye chosen from disperse dyes, acid dyes, cationic dyes, azoic dyes, sulfur dyes, mordant dyes, or any combination thereof, and wherein the first dye and second dye are different.

35. The yarn of claim 34, wherein a sum of the areas of the radial cross-sections of all filaments in a radial cross-section of the yarn varies by 5% or less along a length of the yarn.

36. The yarn of claim 35, wherein for filaments in the same bundle of filaments, the variation in the area of the radial cross-section along the length of each filament occurs at a common radial cross-section of the respective bundle of filaments, the common radial cross-section of the respective bundle of filaments lying within a plane that perpendicularly intersects a central axis of the respective bundle of filaments; and wherein within a plane that perpendicularly intersects a central axis of the yarn, the sum of the areas of radial cross-sections of the filaments in one respective bundle of filaments is different than the sum of areas of radial cross-sections of the filaments in at least one other bundle of filaments.

37-44. (canceled)

45. The system of claim 8, wherein the first polymer is capable of absorbing an acid dye and the second polymer is capable of absorbing a disperse dye.

46. (canceled)

47. The system of claim 45, wherein the first polymer has a first luster type, the first luster type chosen from clear, bright, dull, semi-dull, extra dull, and super dull, wherein the second polymer has a second luster type, the second luster type chosen from clear, bright, dull, semi-dull, extra dull, and super dull, and wherein the first luster type and second luster type are different.

48. (canceled)

49. (canceled)

50. The method of claim 30, further comprising applying a first dye and a second dye to the bundle of filaments, the first dye being different from the second dye.

51-60. (canceled)

61. The method of claim 50, wherein the first polymer is capable of absorbing a first dye, the first dye chosen from disperse dyes, acid dyes, cationic dyes, azoic dyes, sulfur dyes, mordant dyes, or any combination thereof, wherein the second polymer is capable of absorbing a second dye, the second dye chosen from disperse dyes, acid dyes, cationic dyes, azoic dyes, sulfur dyes, mordant dyes, or any combination thereof, and wherein the first dye and the second dye are different.

62. The yarn of claim 36, wherein the at least two bundles of filaments comprise a first set of filaments and a second set of filaments; and wherein the first set of filaments has a first luster type, the first luster type chosen from clear, bright, dull, semi-dull, extra dull, and super dull, wherein the second set of filaments has a second luster type, the second luster type chosen from clear, bright, dull, semi-dull, extra dull, and super dull, and wherein the first luster type and second luster type are different.

63-69. (canceled)
